(19) United States
(12) Patent Application Publication
(10) Pub. No.: US 2004/0134334 A1
(43) Pub. Date: Jul. 15, 2004

(54) Feedback resistant stringed musical instrument

(76) Inventor: Lloyd R. Baggs, Nipomo, CA (US)

Correspondence Address: CHRISTIE, PARKER & HALE, LLP, P.O. BOX 7068, PASADENA, CA, 91109-7068, US

(21) Appl. No.: 10/345,079

(22) Filed: Jan. 14, 2003

(51) Int. Cl. G10H 3/00

(52) U.S. Cl. 84/723

(57) ABSTRACT

A feedback resistant stringed acoustic musical instrument. The stringed acoustic musical instrument includes a body having a sound board and a back with a side portion extending from a peripheral edge of the sound board to a peripheral edge of the back thus creating an enclosure. The side portion includes perforations extending from an exterior surface of the side portion to an interior surface. The perforations reduce or essentially eliminate the tendency of a stringed musical instrument's body to behave as a Helmholtz resonator and the tendency of a an acoustic instrument's sound board to resonate when they are exposed to the instruments's own amplified acoustic signal. The acoustic qualities of the amplified acoustic signal may be further enhanced by using one or more peaking filter circuits in a preamplifier or audio amplifier used to generate the amplified acoustic signal.

### BACKGROUND OF THE INVENTION

This invention pertains generally to the field of musical instruments and more specifically to modifying an acoustic musical instrument to enhance amplification of an acoustic signal generated by the musical instrument without inducing feedback.

Acoustic musical instruments, such as acoustic guitars, have always been difficult to amplify faithfully. The basic problem is not in achieving fidelity but amplifying with fidelity while resisting feedback. The primary reason for feedback is that an acoustic guitar includes an enclosed body or bowl having a top or sound board with a sound hole. The combination of the enclosed body and sound hole creates a loosely tuned Helmholtz resonator, with a resonant frequency of around 130-150 Hz. A mass of air inside the guitar is easily excited by a vibrating top, imparting power, warmth and body to the sound generated by the guitar. This same air mass is also easily excited by airborne vibrations from loudspeakers when the acoustic guitar is amplified, thus causing feedback. A secondary feedback problem is that of the sound board main resonance, usually located between 190 Hz and 220 Hz, being excited sympathetically by airborne vibrations from the speakers.

It is general knowledge that the highest fidelity from a pickup may be achieved with a body pickup attached directly to an acoustic guitar's body. A body pickup responds primarily to vibrations in the acoustic guitar's top and body rather than to the vibrations of the acoustic guitar's strings. But any pickup that faithfully amplifies the vibrations of the acoustic guitar top and body will also amplify the acoustic guitar body's excitable Helmholtz and top main resonance making the amplified acoustic guitar susceptible to feedback. Many techniques have been employed over the years to remedy this pervasive and frustrating problem.

One remedy is to employ string pickups that allow little or no body sound to be amplified. These pickups can be in the form of piezo saddle or undersaddle pickups or magnetic sound hole pickups. These pickups allow for moderately high Sound Pressure Levels (SPLs) but, lacking any top/body sound, fail miserably to faithfully amplify the acoustic guitar. Split systems have been devised using string pickups in combination with body pickups or internal microphones where the body sound has been used primarily with the less feedback prone “house” speakers and the string pickup signal is fed to the feedback producing stage monitors. This can allow high enough performing levels but the low quality string signal from the monitors is discouraging for a guitarist.

Another technique that has been employed is to cover the sound hole completely with some sort of plug to interrupt the connection between the air inside of the instrument and the outside air. One commercially available product, called the “Feedback Buster”, is a rubber plug that fits snugly inside the sound hole. Such products are somewhat effective and can remove the air resonance effect in producing feedback but they are unsightly and do nothing to damp the acoustic guitar's top main resonance.

Another technique that has been tried is modification of an acoustic guitar's sound hole or reflex port. These modifications include changing the reflex port configuration or moving the reflex port to another location on the sound board of the guitar. Such a modification of a guitar is disclosed in U.S. Pat. No. 4,056,034 issued to Kaman. While reflex port modifications may modify the amount of feedback caused by Helmholtz resonator resonance, these modifications do not eliminate air resonance as a major contributor to feedback induced in the amplified guitar system. In addition, these kinds of reflex port modifications may do nothing to reduce the top or sound board main resonance.

Another common feedback control method are the many techniques of pickup signal equalization (EQ) that have been employed. These include simply turning down the bass response of an amplifier coupled to the pickup (this is the primary frequency range where the air and top resonance reside) to employing tuned notch filters coupled to the pickup signal to elaborate computer based “feedback eliminators” that automatically seek feedback and then apply an appropriate filter to damp an offending frequency. These techniques can have minimal to medium effectiveness but there is usually a loss of fidelity when these devices are employed.

Another technique has been the recent trend of using “in-ear” monitors. These monitors are earphones coupled to a belt pack receiver worn by the guitarist that replace the need for floor monitors while performing. Since the floor monitors are a big source of feedback, in-ear monitors are a big help. However, they are not completely effective for loud electric bands where electric and bass guitar on-stage amplifiers and drum kits excite acoustic guitar Helmholtz and top resonances. In-ear monitors are also very expensive and are usually out of the financial reach of working musicians.

This desire to eliminate feedback and still provide an acoustic sound has also given rise to an entire class of performing guitars called Acoustic Electric guitars. These guitars have limited to essentially zero acoustic response but when outfitted with an acoustic pickup they are capable of high volume levels with minimal feedback. However, because of the limited acoustic response of the body, these types of guitars sound only moderately acoustic at best when amplified.

An extension of the acoustic electric guitar is a solid body electric guitar. When fitted with an acoustic bridge pickup the solid body guitars are capable of extremely high sound pressure levels (SPLs) but barely provide an acceptable acoustic sound.

It is apparent that an amplified acoustic instrument that combines high fidelity acoustic sound quality and the feedback resistance of the electric guitar has yet to be achieved but would be highly desirable. Such an instrument could be fitted with a high fidelity body pickup for optimum sound quality and should also achieve high enough SPLs before feedback to be practical in a performing situation.

### SUMMARY OF THE INVENTION

In one aspect of the invention, a feedback resistant stringed acoustic musical instrument is created by perforating a body of the stringed acoustic musical instrument to reduce to the point of essentially eliminating the presence of air resonant effects. The stringed acoustic musical instrument includes a body having a sound board and a back with a side portion extending from a peripheral edge of the sound board to a peripheral edge of the back thus creating an enclosure. The side portion includes perforations extending from an exterior surface of the side portion to an interior surface. The perforations reduce or essentially eliminate the tendency of to stringed musical instrument's body to behave as a Helmholtz resonator when exposed to its own amplified acoustic signal. Thus when the instrument is exposed to it's own signal the instrument is not excited to vibrate at these frequencies.

In another aspect of the invention, the feedback resistant stringed acoustic musical instrument further includes a pickup attached to the perforated body. The pickup is coupled to an audio amplifier to generate the amplified acoustic signal.

In another aspect of the invention, the feedback resistant stringed acoustic musical instrument may include any sort of acoustic pickup such as an undersaddle pickup. The pickup is coupled to an audio amplifier to generate the amplified acoustic signal.

In another aspect of the invention, the acoustic qualities of the amplified acoustic signal may be further enhanced by using peaking filter circuits in an audio amplifier used to generate the amplified acoustic signal. One peaking filter may be tuned with a central frequency of about 130 Hz to 150 Hz with approximately three to eighteen dB of amplification. Another peaking filter may be tuned to a center frequency of about 190 Hz to 230 Hz with approximately three to twelve dB of amplification.

In another aspect of the invention, the perforations may be circular, or may be elongated slots having a longitudinal axis substantially parallel to a plane defined by an exterior surface of the sound board, or may be of any shape.

In another aspect of the invention, the total area of the perforations may be varied depending on the total volume of air enclosed in the perforated body, the overall shape of the perforated body, the material used to make the perforated body, the presence and size of a sound hole in the sound board etc. For example, in one perforated body in accordance with the present invention, the perforated body has more than 0.003 square inches of perforation surface area per cubic inch of enclosed volume.

In another aspect of the invention, the back further includes one or more perforations extending from the interior surface to the exterior surface. The perforations of the back may be circular, or may be elongated slots having a longitudinal axis substantially aligned with a longitudinal axis defined by the neck, or may be of any shape.

In another aspect of the invention, a feedback resistant stringed acoustic musical instrument includes a perforated body having a sound board and a back with a side portion extending from a peripheral edge of the sound board to a peripheral edge of the back creating an enclosure. The back has an interior surface and an exterior surface with the back including one or more perforations extending from the interior surface to the exterior surface. The stringed acoustic musical instrument further includes a neck having a head at a first end and a heel at a second end, with the neck being coupled to the body at the heel end. One or more strings are removably attached to the sound board at a first string end and removably attached to the head at a second string end.

In another aspect of the invention, the feedback resistant stringed acoustic musical instrument includes a sound board having a sound hole extending from an exterior surface of the sound board to an interior surface of the sound board.

In another aspect of the invention, a feedback resistant stringed acoustic musical instrument includes a backless body having a sound board supported by bracing. The instrument has a neck with a head at a first end and a heel at a second end and the neck is coupled to the body at the heel end. One or more strings are attached to the sound board at a first string end and attached to the head at a second string end.

In another aspect of the invention, the backless feedback resistant stringed acoustic musical instrument further includes a pickup attached to the musical instrument and an amplifier coupled to the pickup. The amplifier may include one or more peaking filter circuits with one peaking filter circuit having a center frequency between 130 Hz and 150 Hz and another peaking filter circuit having a center frequency between 190 Hz and 230 Hz.

### BRIEF DESCRIPTION OF THE DRAWINGS

These and other features, aspects, and advantages of the present invention will become better understood with regard to the following description, appended claims, and accompanying drawings where:

FIG. 1 is a perspective drawing of a musical instrument with body perforations in accordance with an exemplary embodiment of the present invention;

FIG. 2a is a cross sectional schematic diagram illustrating a Helmholtz resonator resonance mode in a conventional musical instrument;

FIG. 2b is a cross sectional schematic diagram illustrating reduction to the point of essentially eliminating a Helmholtz resonator resonance mode in a musical instrument with body perforations in accordance with an exemplary embodiment of the present invention;

FIG. 3 is a perspective drawing of a back and a side of a musical instrument with back and side perforations in accordance with an exemplary embodiment of the present invention;

FIG. 4 is a perspective drawing of a back and a side of a musical instrument with back perforations in accordance with an exemplary embodiment of the present invention;

FIG. 5 is a perspective drawing of a musical instrument with no body in accordance with an exemplary embodiment of the present invention;

FIG. 6 is a perspective drawing of a musical instrument with body perforations and a sound hole in accordance with an exemplary embodiment of the present invention; and

FIG. 7 is a perspective drawing of a stringed musical instrument having a perforated body with a perforated top portion in accordance with an exemplary embodiment of the present invention.

### DETAILED DESCRIPTION

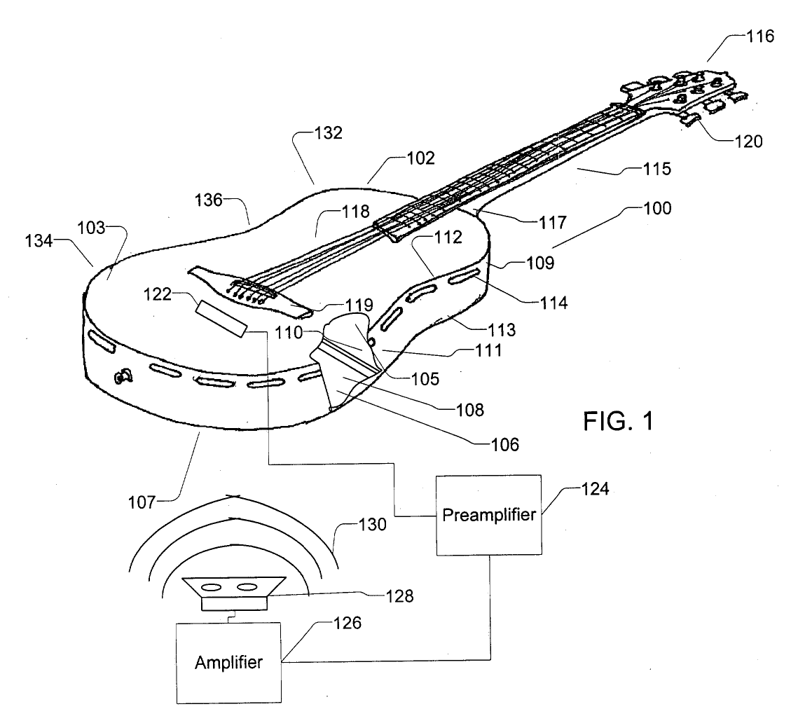

FIG. 1 is a perspective drawing of a musical instrument with body perforations in accordance with an exemplary embodiment of the present invention. A musical instrument 100, such as a guitar, includes a perforated body 102. The perforated body has a sound board or top portion 103. The top portion has an outer surface 104 and an inner surface 105. The perforated body also includes a back portion 106. The back portion includes an outer surface 107 and an inner surface 108. The perforated body also includes a side portion 109 having an inner surface 110 and an outer surface 111. As illustrated in the perspective drawing, the top portion and the back portion are substantially parallel to each other. The side portion extends from peripheral edge 112 of the top portion to a peripheral edge 113 of the bottom portion coupling and separating the top portion and the back portions to create an enclosed body for the musical instrument. The side portion includes one or more perforations 114 extending from the inner surface to the outer surface of the side portion thus creating a perforated body.

The musical instrument further includes a neck 115 having a head 116 at a first end and a heel 117 at a second end. The neck is fixedly coupled to the perforated body by the heel. One or more strings 118 are each removably coupled to the outer surface of the top portion of the perforated body by a saddle and bridge assembly 119 at a first end portion of each string. Each string is also removably coupled to the head by winding a second end portion of each string around a tuning peg 120 located on the head. The tension of the each string is adjusted using the tuning peg so that plucking a string causes the string to vibrate. As the string vibrates, vibrational energy from the string is transferred to the top portion of the perforated body causing the top portion to vibrate in unison with the plucked string.

In operation, the vibrations of the top portion of the perforated body are sensed by a transducer or pickup 122 coupled to a surface of the top portion of the perforated body. The pickup transduces the mechanical vibrations of the top portion into electrical signals that are then transmitted to a preamplifier 124. The preamplifier receives the electrical signals and generates amplified electrical signals which are transmitted to an audio amplifier 126. The audio amplifier further amplifies the electrical signals to generate electrical signals that are used to drive a loudspeaker 128 thus generating an amplified acoustic signal 130 representative of the original vibrational energy of the top portion of the musical instrument.

In a musical instrument with a perforated body in accordance with an exemplary embodiment of the present invention, the perforations are elongated creating one or more slots with a longitudinal axis substantially parallel to a plane defined by an exterior surface of the sound board. The slots may vary from 1/4″ to 3/8″ in width and may be about two inches long. In another perforated body in accordance with an exemplary embodiment of the present invention, the perforations are circular. In other embodiments, the perforations may have a complex or decorative shape.

The total area of the perforations may be varied depending on the total volume of air enclosed in the perforated body, the overall shape of the perforated body, the material used to make the perforated body, the presence and size of a sound hole in the sound board etc. For example, in one perforated body in accordance with the present invention, the perforated body had an enclosed volume of approximately 800 cubic inches. The perforated body began to exhibit feedback resistance, meaning feedback generated by the perforated body was reduced, with around three square inches of total perforation area or at a ratio of 0.00375 square inches of perforation surface area per cubic inch of enclosed volume. As the total surface area of the perforations increased, so did feedback resistance. When the total surface area of the perforations was increased to about nine square inches, or a ratio of 0.01125 square inches of perforation surface area per cubic inch of enclosed volume, the capacity of a testing apparatus used to test the feedback resistance was exceeded. Therefore, in this example, no upper bound was determined for a maximum effective surface area to volume ratio.

The precise location of the perforations may be altered without deviating from the spirit of the invention. In the perforated body illustrated in FIG. 1, the perforations are shown as being nearer to the peripheral edge of top portion than the peripheral edge of the back portion. In other perforated bodies in accordance with exemplary embodiments of the present invention, the perforations are located nearer the peripheral edge of the back portion. In other embodiments, the perforations are evenly distributed between the top portion and the back portion. In addition, as illustrated in FIG. 1, the perforations are uniformly distributed around a circumference of the side portion.

In another perforated body in accordance with an exemplary embodiment of the present invention, the perforations on the side portion are located on one side of a longitudinal axis defined by the neck. In this case, the perforations may be on the side closest to a musician playing the musical instrument.

Those skilled in the art of manufacturing stringed musical instruments will readily appreciate that the perforated body of the musical instrument can be modified in a variety of ways without deviating from the spirit of the invention. For example, as illustrated in the figure, the top portion and back portion are substantially flat. Those skilled in the art of manufacturing stringed musical instruments will readily appreciate that the top portion and the back portion may be flat, concave, convex, or have a compound curved shape in accordance with aesthetic tastes.

As illustrated above, the perforated body has a first bout 132 and a second bout 134 with a waist portion 136 therebetween. In other perforated bodies in accordance with exemplary embodiments of the present invention, the perforated bodies may include more than two bouts, and therefore more than one waist, or may have only one bout, and therefore have no waist.

There are many materials suitable for use in constructing the top portion, side portion, and back portion. For example, in one musical instrument with a perforated body in accordance with an exemplary embodiment of the present invention, the perforated body is made from a synthetic material such as plastic or fiberglass. In other embodiments, the material used for the construction of the perforated body may be wood.

In a musical instrument with a perforated body in accordance with an exemplary embodiment of the present invention, the back portion and side portion are of unitary construction. In this embodiment, the body may assume a bowl shape having side portions and back portions with compound curves such as found on a lute or mandolin.

As illustrated above, a musical instrument with a perforated body is used in conjunction with a preamplifier and an amplifier. While the preamplifier is not essential for amplification of the electrical signals produced by the pickup, the preamplifier may provide additional features through the use of filtering circuits included in the preamplifier. For example, filter circuits in the preamplifier can be used to compensate for the musical instrument's lack of resonance in certain frequency ranges. As most acoustic musical instruments have some Helmholtz resonance, this resonance has become associated with acoustic musical instruments as a desirable quality. In one musical instrument with a perforated body in accordance with an exemplary embodiment of the present invention, a preamplifier with a peaking filter circuit is used to replicate the desirable resonance caused by the Helmholtz resonator resonance of a conventional musical instrument body while still retaining the musical instrument's ability to reject feedback. In this case, a peaking filter may be tuned with a central frequency of about 130 Hz to 150 Hz with approximately three to eighteen dB of amplification. In another embodiment, another peaking filter may be tuned to a center frequency of about 190 Hz to 230 Hz with approximately three to twelve dB of amplification in order to replicate the desirable main top or sound board resonance of a conventional acoustic guitar.

Those skilled in the art of amplifying acoustic musical instruments will recognize that many styles of pickups may be used to transduce acoustic vibrations of the musical instrument into electrical signals. For example, as illustrated above, a body pickup attached to a surface of the perforated body may be used. In other embodiments, a string pickup may be used, or an under saddle pickup may be used, etc.

Any type of amplified stringed musical instrument may benefit from the features of the present invention. For example, an acoustic bass is notoriously difficult to amplify because of its low frequency Helmholtz resonator resonance.

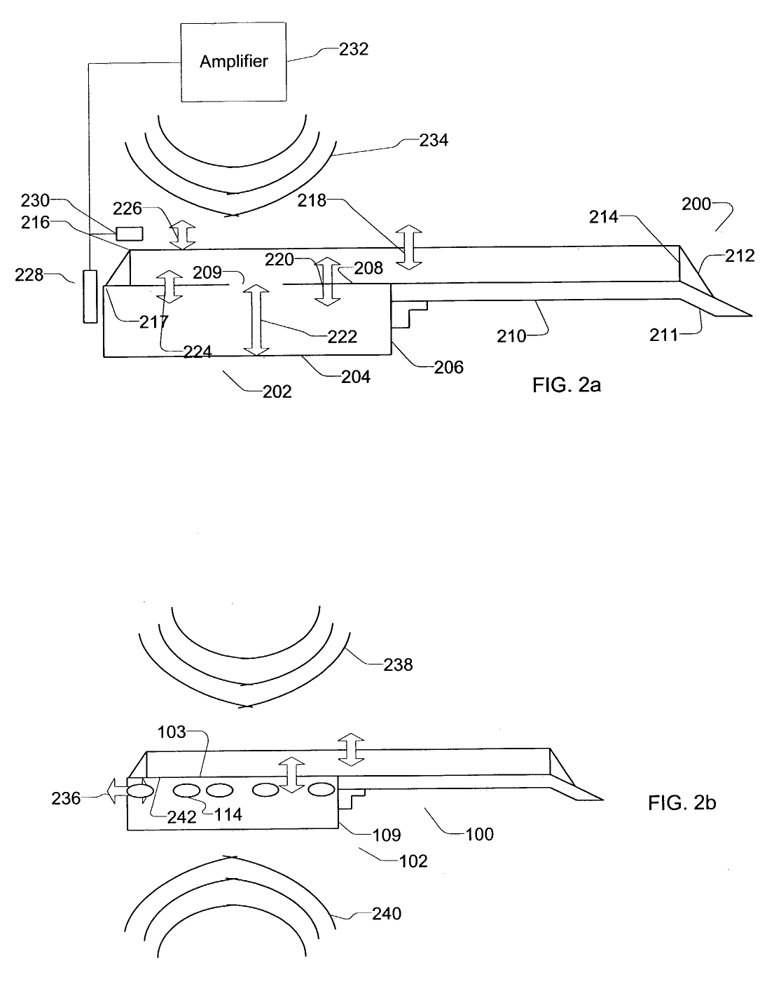

FIG. 2a is a schematic diagram illustrating a Helmholtz resonance mode in a conventional musical instrument. A conventional musical instrument 200 includes a body 202 having a back portion 204, a side portion 206, and a sound board-or top portion 208. The side portion extends from the top portion to the back portion joining the top and back portions together to form an enclosure. The top portion has one or more openings 209 while the side and back portions have no openings. A neck 210 is coupled to the body. The neck includes a head 211 to which one or more strings 212 are attached at a first end portion. The strings pass over a nut 214 and extend to a saddle 216 and attach to the body at a bridge assembly 217. In operation, a plucked string vibrates 218 and transfers some of its vibrational energy to the top portion. The top portion vibrates 220 in response to the vibrational energy transferred to the top portion by the vibrating string. As the top portion vibrates, some of the top portion's vibrational energy 222 is transferred to a mass of air enclosed in the body.

The construction of the body is such that the coupled back portion, side portion, and top portion including the opening create a Helmoholtz resonator. To a first approximation, the resonant frequency of the resultant Helmholtz resonator is given by the equation:

$$f = \frac{c}{2 π} \sqrt{\frac{S}{V L}}$$

Where:

f=Resonant frequency

c=speed of sound in air

S=size of opening in top portion of body

V=enclosed volume of air in body

L=length of opening in top portion of body

For a conventional guitar, the resonant frequency is around 130 Hz to 150 Hz. If the frequency of the vibrational energy transferred to the mass of air by the top portion of the enclosed body is near the resonant frequency of the Helmholtz resonator, the Helmholtz resonator is driven into a resonant mode. As a result, the SPL at the Helmholtz resonator's resonant frequency inside of the enclosed body increases as indicated by arrow 222. As the SPL caused by resonance inside the body increases, vibrational energy 224 is transferred from the mass of air in the body to the top portion of the body and thus vibrational energy 226 is transferred to the attached strings as well. This vibrational energy may be sensed by a body pickup 228 or a string pickup 230 where the vibrational energy is transduced into an electrical signal that is transmitted to an amplifier 232 which amplifies the electrical signal to generate an acoustical signal 234 that impinges on the musical instrument. As the acoustical signal has the same frequency as the Helmholtz resonator defined by the musical instrument's body, the Helmholtz resonator becomes an oscillator driven at its resonant frequency, thus causing unwanted acoustical energy at the resonant frequency.

FIG. 2b is a cross sectional diagram illustrating reduction to the point of essentially eliminating Helmholtz resonator resonance in a musical instrument with body perforations in accordance with an exemplary embodiment of the present invention. In a musical instrument 100 with body perforations in accordance with an exemplary embodiment of the present invention, a plurality of perforations 114 pass through a side portion 109 of a perforated body 102. Not to be bound by theory, the perforations prevent the creation of a Helmholtz resonator by eliminating one of the required elements of such a resonator, namely that the resonator has rigid or semi-rigid sides. As a result, sound pressure waves 236 generated in the perforated body by vibration of a top portion 103 of the perforated body have the ability to pass through the perforated body rather than being contained within the body. This reduces to the point of essentially eliminating the tendency of the perforated body to become a Helmholtz resonator as the perforated body does not have sides which are rigid or semi-rigid.

Another feature of the perforated body is that it reduces to the point of essentially eliminating the tendency of the top portion to become uncontrollably excited and resonant when in the presence of an exterior acoustic wave 238 with a frequency approximating the resonant frequency of the top portion. Not to be bound by theory, this reduction or caused by a second set of acoustic waves 240 now being able to reach an interior surface 242 of the top portion. If the phase and amplitude of the first and second set of acoustic waves are similar, there will be no net pressure differential across the top portion of the guitar thus the two sets of acoustic waves will have a tendency to cancel each other out with the result that little net vibrational energy is transferred to the top portion. The second set of acoustic waves may result from refractions of the first set of acoustic waves around the body of the stringed instrument. The first set of acoustic waves impinging on a surface of the top portion of the guitar will have a tendency to refract A conventional stringed instrument may have body dimensions substantially smaller than the wavelength of a problematic audible acoustic wave. For example, for a stringed instrument, such as a guitar, the top portion may be around two feet long by one and one half feet wide. Such a guitar may have a sound board main resonance of around 200 Hz. A set of acoustic waves having a frequency of 200 Hz will have a wave length of approximately six feet at standard conditions. As the wavelength of six feet is much larger than the largest dimension of the guitar, impinging acoustic waves having a frequency of 200 Hz will diffract around the top portion of the guitar rather than creating an acoustic shadow behind the guitar's top portion. As such, the sound field in front of immediately behind the top portion of the guitar will have similar characteristics of amplitude and phase.

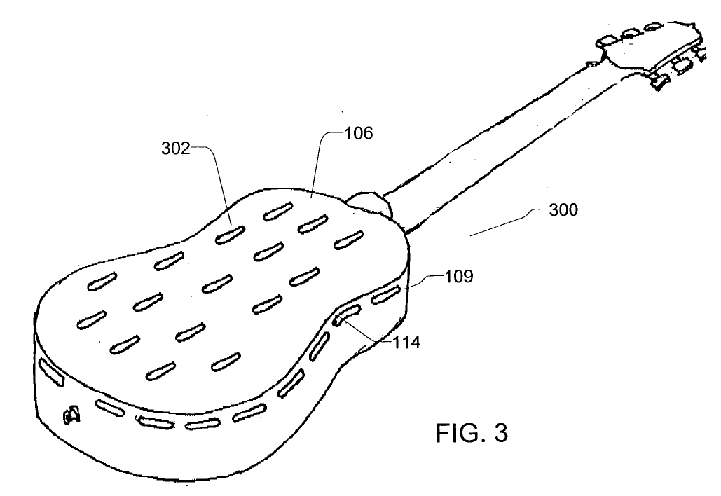

FIG. 3 is a perspective drawing of a back and a side of a musical instrument with back and side perforations in accordance with an exemplary embodiment of the present invention. A musical instrument 300 includes a perforated body 102 wherein a back portion 106 has an interior surface and an exterior surface as previously described. One or more perforations 302 extend from the interior surface to the exterior surface. In this case, a side portion 109 of the perforated body also includes perforations 114 as previously described.

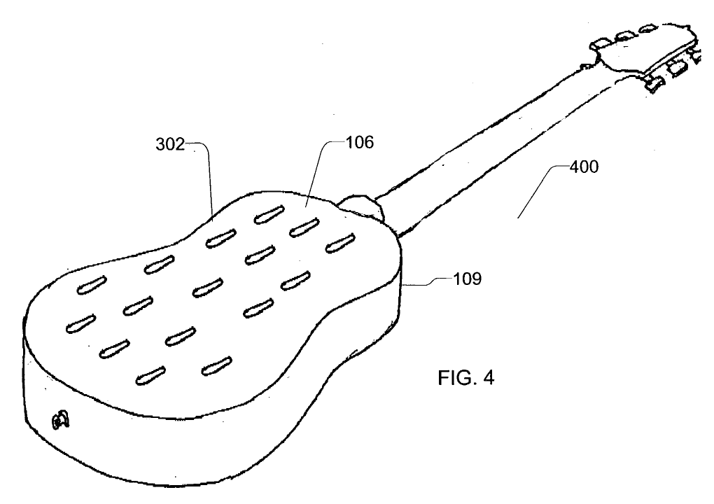

FIG. 4 is a perspective drawing of a back and a side of a musical instrument with back perforations in accordance with an exemplary embodiment of the present invention. A musical instrument 400 includes a perforated body 102 wherein a back portion 106 has an interior surface and an exterior surface as previously described. One or more perforations 302 extend from the interior surface to the exterior surface. In this case, a side portion 109 of the perforated body does not include any perforations as previously described.

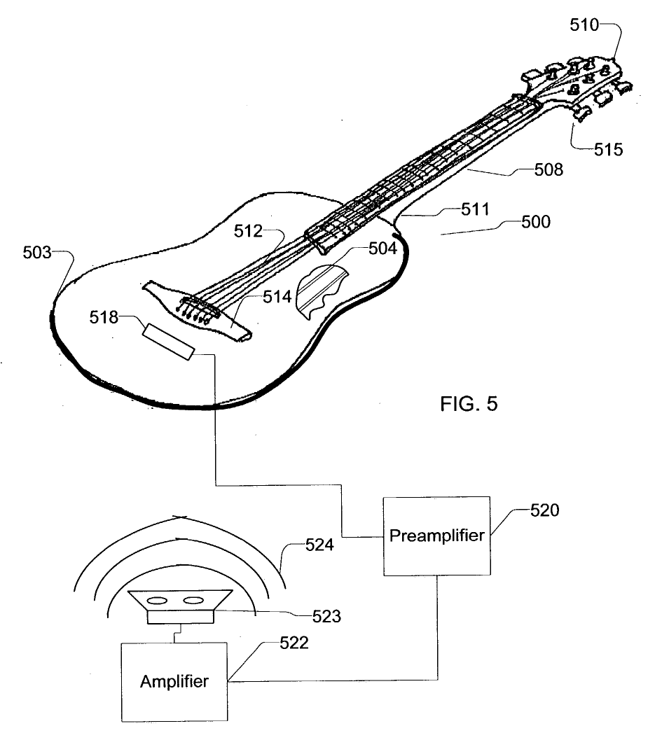

FIG. 5 is a perspective drawing of a top of a musical instrument with no body in accordance with an exemplary embodiment of the present invention. A musical instrument 500 includes a sound board or top portion 503. The top board is supported by bracing 504. The musical instrument further includes a neck 508 having a head 510 at a first end and a heel 511 at a second end. The neck is coupled via the heel to the top portion. One or more strings 512 are fixedly connected to the head of the neck and to the outer surface of the top portion by a saddle and bridge assembly 514 at a first end portion of each string. The strings are connected to the head by winding a second end portion of each string around a tuning peg 515 located on the head. The tension of the strings is adjusted so that plucking a string causes the string to vibrate. As the string vibrates, vibrational energy is transferred from the vibrating string to the top portion causing the top portion to vibrate in unison with the plucked string.

In operation, the vibrations of the top portion are sensed by a pickup 518 coupled to a surface of the top portion. The pickup transduces the mechanical vibrations of the top portion into electrical signals that are then transmitted to a preamplifier 520. The preamplifier receives the electrical signals and generates amplified electrical signals which are transmitted to an audio amplifier 522. The audio amplifier further amplifies the already amplified electrical signals to generate an electrical signal that is used to drive a loudspeaker 523 thus generating an acoustic signal 524.

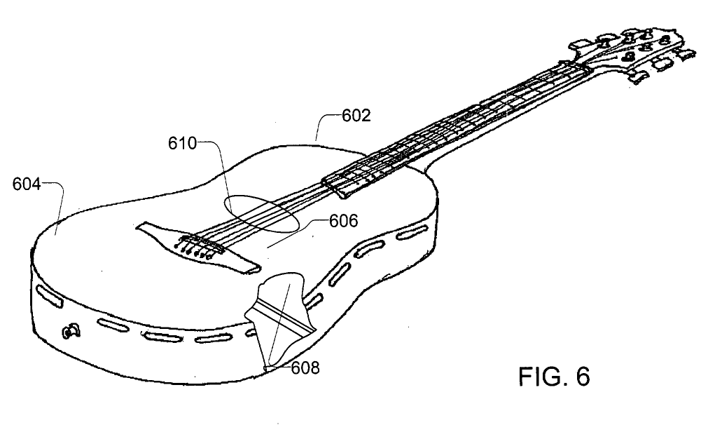

FIG. 6 is a perspective drawing of a musical instrument with body perforations and a sound hole in accordance with an exemplary embodiment of the present invention. In a musical instrument 600 with a perforated body 602 in accordance with an exemplary embodiment of the present invention, a top portion 604 of the perforated body includes an inner surface 606 and an outer surface 608. One or more openings or sound holes 610 extend from the top portions inner surface to its outer surface. Such an opening may be at any location on the top portion of the perforated body.

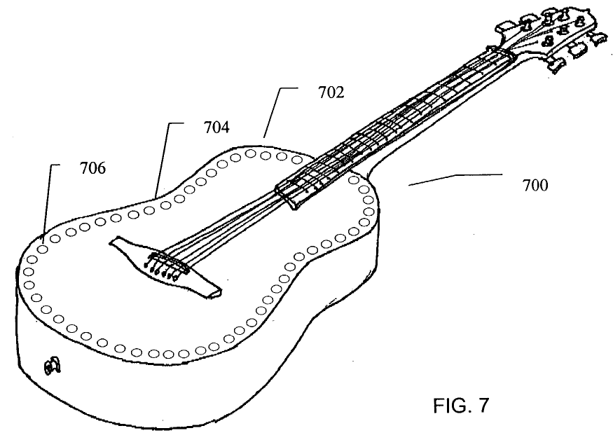

FIG. 7 is a perspective drawing of a stringed musical instrument having a perforated body with a perforated top portion in accordance with an exemplary embodiment of the present invention. A stringed musical instrument 700 may have a top portion 802 with a plurality of perforations 804 around a peripheral edge 806 of the top portion.

As illustrated in FIG. 3, FIG. 4, FIG. 6, and FIG. 7 a side portion may be perforated, a back portion may be perforated, and a top or sound board may include a sound hole, and a top portion may be perforated in accordance with the present invention. In addition, as noted above, the total surface area of the perforations may be increased or decreased. As some of these features are non-exclusive, these features may be mixed in various combinations without deviating from the spirit of the invention. For example, in one perforated body in accordance with the present invention, the top does not include a sound hole, and the back portion and the side portion are heavily perforated. In another embodiment, the top portion does not include a sound hole, the back is not perforated, and the side portion is lightly perforated. In another embodiment, the top portion includes a sound hole, the back portion is not perforated, and the side portion is heavily perforated. In another embodiment, the top portion includes a sound hole, and the back and side portions are heavily perforated.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claims' equivalents rather than the foregoing description.

What is claimed is:

1. A feedback resistant stringed acoustic musical instrument, comprising:
a perforated body comprising,
a sound board;
a back; and
a side portion extending from a peripheral edge of the sound board to a peripheral edge of the back creating an enclosure, the side portion having an interior surface and an exterior surface, the side portion including one or more perforations extending from the interior surface to the exterior surface;
a neck having a head at a first end and a heel at a second end, the neck coupled to the body at the heel end; and
one or more strings attached to the sound board at a first string end and attached to the head at a second string end.

2. The feedback resistant stringed acoustic musical instrument of claim 1, further comprising;
a pickup attached to the musical instrument; and
an amplifier coupled to the pickup.

3. The feedback resistant stringed acoustic musical instrument of claim 2, wherein the amplifier further includes one or more peaking filter circuits.

4. The feedback resistant stringed acoustic musical instrument of claim 3, wherein a peaking filter circuit has a center frequency between 130 Hz and 150 Hz.

5. The feedback resistant stringed acoustic musical instrument of claim 3, wherein a peaking filter circuit has a center frequency between 190 Hz and 230 Hz.

6. The feedback resistant stringed acoustic musical instrument of claim 1, wherein the perforations are elongated slots having a longitudinal axis substantially parallel to a plane defined by an exterior surface of the sound board.

7. The feedback resistant stringed acoustic musical instrument of claim 1, wherein the ratio of total surface area of the perforations to volume of enclosed air in the body is greater than approximately 0.003 square inches of perforation surface area per cubic inch of enclosed volume.

8. The feedback resistant stringed acoustic musical instrument of claim 1, wherein the back has an exterior surface and an interior surface, the back further comprising one or more perforations extending from the interior surface to the exterior surface.

9. The feedback resistant stringed acoustic musical instrument of claim 7, wherein the perforations of the back are elongated slots having a longitudinal axis substantially aligned with a longitudinal axis defined by the neck.

10. The feedback resistant stringed acoustic musical instrument of claim 1, wherein the back and side portion are of unitary construction.

11. The feedback resistant stringed acoustic musical instrument of claim 1, wherein the sound board includes a sound hole extending from an exterior surface of the sound board to an interior surface of the sound board.

12. A feedback resistant stringed acoustic musical instrument, comprising:
a perforated body comprising,
a sound board;
a back, the back having an interior surface and an exterior surface, the back including one or more perforations extending from the interior surface to the exterior surface; and
a side portion extending from a peripheral edge of the sound board to a peripheral edge of the back creating an enclosure;
a neck having a head at a first end and a heel at a second end, the neck coupled to the body at the heel end; and
one or more strings attached to the sound board at a first string end and attached to the head at a second string end.

13. The feedback resistant stringed acoustic musical instrument of claim 12, further comprising;
a pickup attached to the musical instrument; and
an amplifier coupled to the pickup.

14. The feedback resistant stringed acoustic musical instrument of claim 13, wherein the amplifier further includes one or more peaking filter circuits.

15. The feedback resistant stringed acoustic musical instrument of claim 14, wherein a peaking filter circuit has a center frequency between 130 Hz and 150 Hz.

16. The feedback resistant stringed acoustic musical instrument of claim 14, wherein a peaking filter circuit has a center frequency between 190 Hz and 230 Hz.

17. The feedback resistant stringed acoustic musical instrument of claim 12, wherein the ratio of total surface area of the perforations to volume of enclosed air in the body is greater than approximately 0.003 square inches of perforation surface area per cubic inch of enclosed volume.

18. The feedback resistant stringed acoustic musical instrument of claim 12, wherein the perforations of the back are elongated slots having a longitudinal axis substantially aligned with a longitudinal axis defined by the neck.

19. The feedback resistant stringed acoustic musical instrument of claim 1, wherein the back and side portion are of unitary construction.

20. The feedback resistant stringed acoustic musical instrument of claim 1, wherein the sound board includes a sound hole extending from an exterior surface of the sound board to an interior surface of the sound board.

21. A feedback resistant stringed acoustic musical instrument, comprising:
a backless body comprising,
a sound board; and
bracing supporting the sound board;
a neck having a head at a first end and a heel at a second end, the neck coupled to the body at the heel end; and
one or more strings attached to the sound board at a first string end and attached to the head at a second string end.

22. The feedback resistant stringed acoustic musical instrument of claim 21, further comprising;
a pickup attached to the musical instrument; and
an amplifier coupled to the pickup.

23. The feedback resistant stringed acoustic musical instrument of claim 22, wherein the amplifier further includes one or more peaking filter circuits.

24. The feedback resistant stringed acoustic musical instrument of claim 23, wherein a peaking filter circuit has a center frequency between 130 Hz and 150 Hz.

25. The feedback resistant stringed acoustic musical instrument of claim 23, wherein a peaking filter circuit has a center frequency between 190 Hz and 230 Hz.

26. A feedback resistant stringed acoustic musical instrument, comprising:
a perforated body comprising,
a sound board, the sound board having an interior surface and an exterior surface, the sound board including one or more perforations extending from the interior surface to the exterior surface at a peripheral edge of the sound board;
a back; and
a side portion extending from the peripheral edge of the sound board to a peripheral edge of the back creating an enclosure.
a neck having a head at a first end and a heel at a second end, the neck coupled to the body at the heel end; and
one or more strings attached to the sound board at a first string end and attached to the head at a second string end.

27. The feedback resistant stringed acoustic musical instrument of claim 26, further comprising;
a pickup attached to the musical instrument; and
an amplifier coupled to the pickup.

28. The feedback resistant stringed acoustic musical instrument of claim 27, wherein the amplifier further includes one or more peaking filter circuits.

29. The feedback resistant stringed acoustic musical instrument of claim 28, wherein a peaking filter circuit has a center frequency between 130 Hz and 150 Hz.

30. The feedback resistant stringed acoustic musical instrument of claim 28, wherein a peaking filter circuit has a center frequency between 190 Hz and 230 Hz.

31. The feedback resistant stringed acoustic musical instrument of claim 1, wherein the sound board includes a sound hole extending from the exterior surface of the sound board to the interior surface of the sound board.
